(19) United States
(12) Patent Application Publication
(10) Pub. No.: US 2005/0178413 A1
(43) Pub. Date: Aug. 18, 2005

(54) Cleaning device for a combustion chamber

(76) Inventor: Mei Hua Chiang, Changhua Hsien (TW)

Correspondence Address: LEANG C. LEI, PMB# 1008 1867 YGNACIO VALLEY ROAD, WALNUT CREEK, CA, 94598, US

(21) Appl. No.: 10/777,112

(22) Filed: Feb. 13, 2004

(51) Int. Cl. B08B 3/04

(52) U.S. Cl. 134/169 A; 134/166 R; 134/169 R; 134/102.2

(57) ABSTRACT

Cleaning device for a combustion chamber is disclosed. The cleaning device for a combustion chamber having a hollow tank for storage a liquid mounted with a tubing module and a connection hole for connecting with an air-inlet tube, characterized in that the top face of the tank is provided with a liquid inlet hole having a threaded cap, and the top end of the tank is an liquid-out connection hole for mounting with the tubing module, and the tubing module is connected to a spraying gun tube, and the air-inlet tube does not extend into the liquid in the tank, and the tubing module has an air-mixing tube and a combination tube in communication with the interior of the air-mixing tube, and the combination tube extends into the liquid, and the surrounding of the air-mixing tube is a pressure-increase hole having a height higher than the height of the liquid, and the pressure-increase hole is in communication with the air-mixing chamber and the interior of the tank; whereby a cleaning device for combustion chamber is obtained.

### BACKGROUND OF THE INVENTION

(a) Technical Field of the Invention

The present invention relates to a cleaning device for a combustion chamber, and in particular, a cleaning device for cleaning the combustion chamber of internal combustion chamber, employing an atomized cleaning solution to clean off accumulated carbon.

(b) Description of the Prior Art

FIG. 1 is a conventional device for combustion chamber comprising a tank 10 for containing a liquid. A Y-shaped tubing 15 is extended from the top end of the tank to the bottom end thereof. The top end of the Y-shaped tubing 15 at the tank 10 is connected to an air-inlet tube 20 and a spray gun tube 25. The Y-shaped tubing 15, adjacent to the air-inlet tube 20, above the level of the cleaning liquid is an air-inlet hole 16 so that when a high pressurized air enters the tank 10 via the air-inlet tube 20, the high pressurized air enters from the air-outlet hole to the top level of the cleaning liquid and a pressure is exerted, and the cleaning liquid is delivered from the bottom of the Y-shaped tubing 15 to the spray gun tube 25 so that the cleaning solution from the bottom section of the Y-shaped tubing 15 is delivered to the spray gun tube 25 so that the cleaning solution is ejected into the combustion chamber by the spray gun tube 25 with a high pressure and speed and the object of cleaning the combustion chamber of the internal combustion engine with the cleaning solution is attained.

However, in practical, there are problems. As shown in FIG. 2, the Y-shaped tubing 15 in the tank 10 after application, when the high pressurized air inlet tube 20 is unplugged, and the spray gun tube 25 of the spray gun is in a closed status, the cleaning solution within the tank 10 will flow in a reverse direction along the air inlet tube 20. This will cause the cleaning solution to eject upward and be wasted. This is a waste and not necessary and the environment is polluted In view of the above, it is therefore an object of the present invention to provide a cleaning device for combustion chamber which mitigates the above drawbacks.

### SUMMARY OF THE INVENTION

Accordingly, it is an object of the present invention to provide a cleaning device for a combustion chamber, which mitigates the above drawbacks by using a non-reversible flow structure, and a foam which cleans the combustion chamber, improving the efficiency of cleaning carbon.

Yet another object of the present invention is to provide a cleaning device for a combustion chamber having a hollow tank for storage a liquid mounted with a tubing module and a connection hole for connecting with an air-inlet tube, characterized in that the top face of the tank is provided with a liquid inlet hole having a threaded cap, and the top end of the tank is an liquid-out connection hole for mounting with the tubing module, and the tubing module is connected to a spraying gun tube, and the air-inlet tube does not extend into the liquid in the tank and the tubing module has an air-mixing tube and a combination tube in communication with the interior of the air-mixing tube, and the combination tube extends into the liquid, and the surrounding of the air-mixing tube is a pressure-increase hole having a height higher than the height of the liquid, and the pressure-increase hole is in communication with the air-mixing chamber and the interior of the tank; whereby a cleaning device for combustion chamber is obtained.

A further object of the present invention is to provide a cleaning device for a combustion chamber, wherein the cleaning solution is atomized prior to spraying so as to improve cleaning efficiency of the cleaning device.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view of a conventional cleaning device for a combustion chamber.

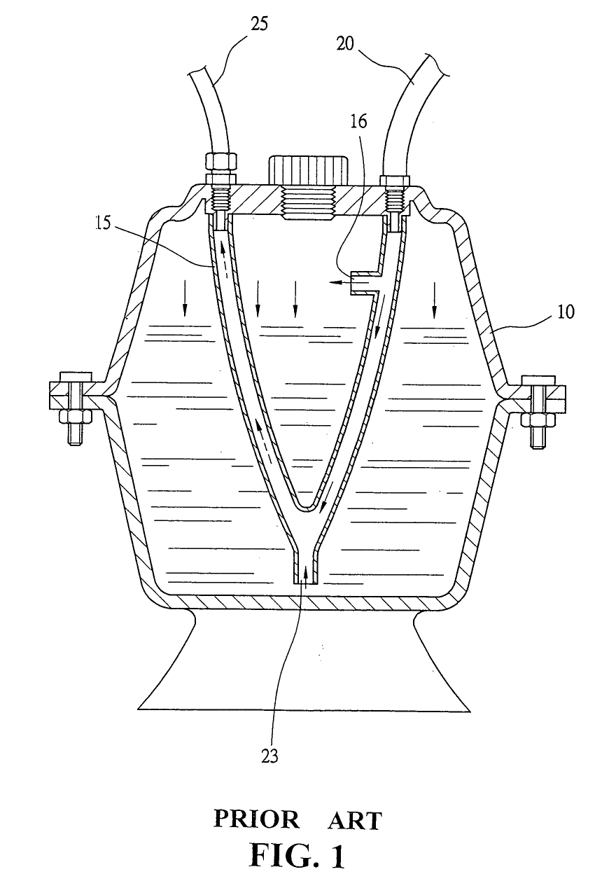

FIG. 2 is a schematic view showing the leakage of cleaning solution from the conventional cleaning device.

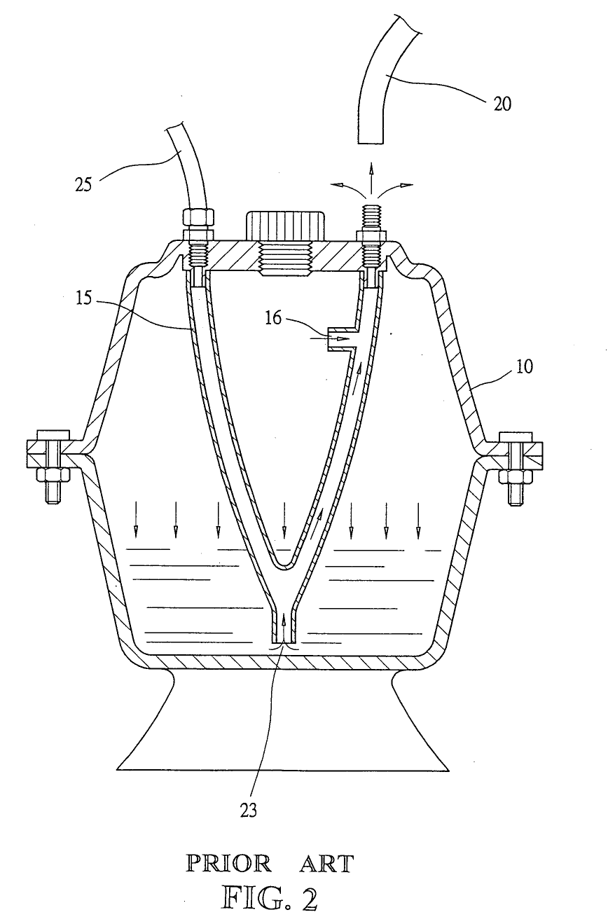

FIG. 3 is a perspective exploded view of a of the present invention.

FIG. 4 is a schematic sectional view of the present invention.

FIG. 5 is a schematic sectional view of the present invention.

FIG. 6 is a schematic view showing the application in accordance with the present invention.

FIG. 7 is a schematic view showing the interior of another preferred embodiment of the present invention.

FIG. 8 is a schematic view showing the interior of another preferred embodiment of the present invention.

FIG. 9 is a schematic view showing the interior of another preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

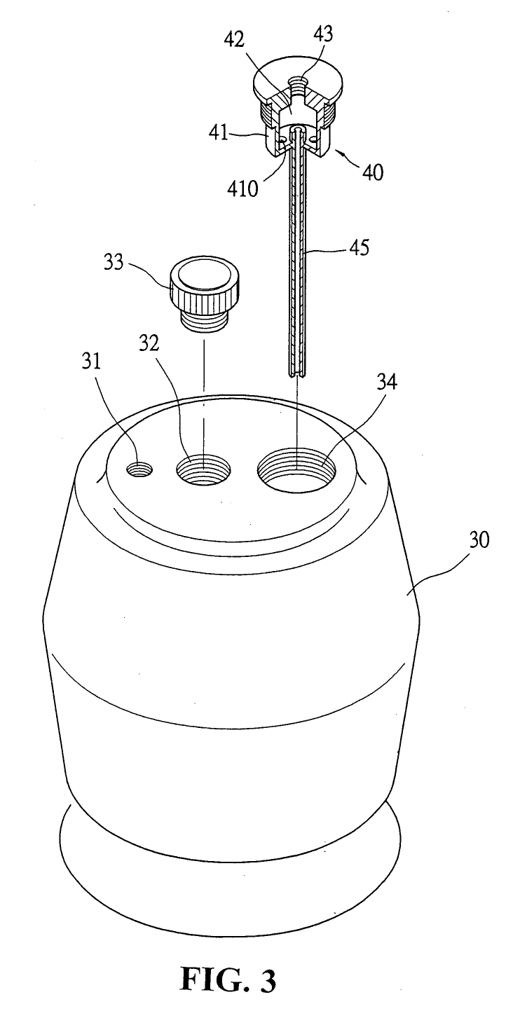

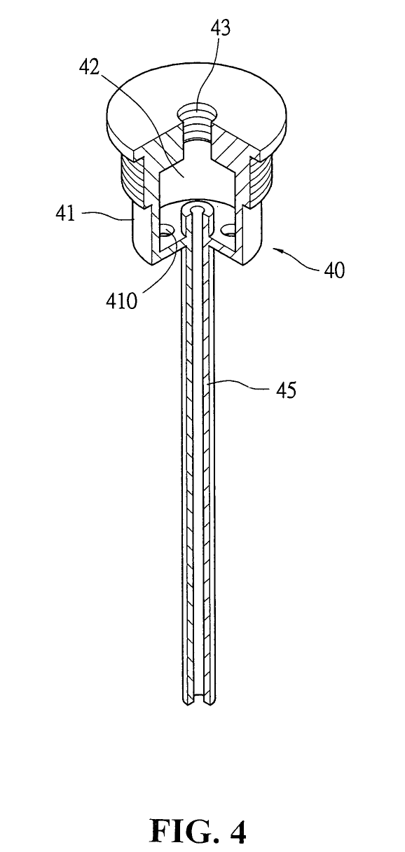

Referring to FIGS. 3 and 4, there is shown a cleaning device for a combustion chamber having a hollow tank 30 for containing a cleaning liquid. The tank 30 is mounted with a tubing module 40, and the tank 30 is provided with an air pressure connection hole 31 for locking to a serially connecting tube 35 so that the connecting tube 35 is connected to a high pressure air inlet tube 50. The top face of the tank 30 is formed with a liquid inlet hole 32 having a threaded cap 33 for the supplying of cleaning liquid. The top end of the tank 30 is formed into a liquid outlet connection hole 34, and the liquid outlet connection hole 34 is for the locking to the tubing module 40 of the spray gun tube 55.

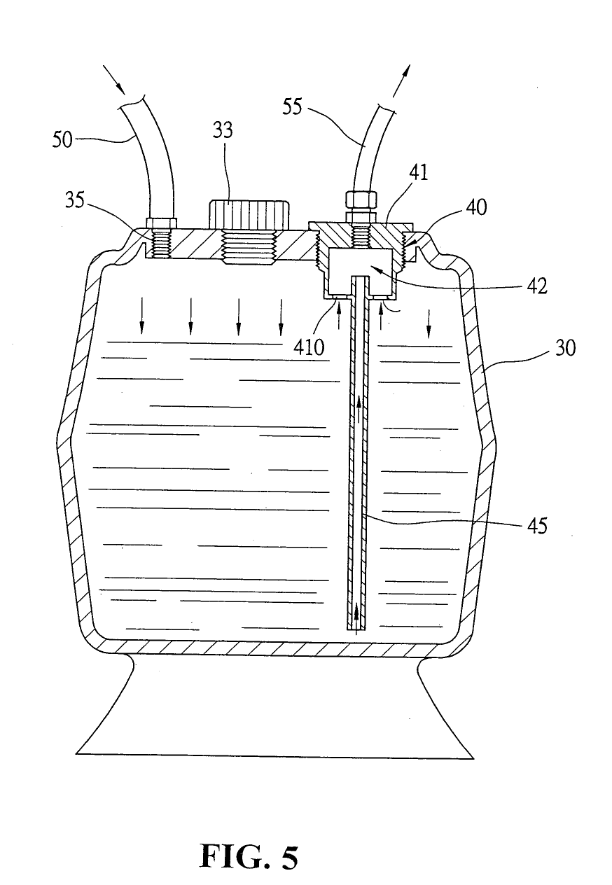

Referring to FIGS. 4 and 5, the tubing module 50 is provided with an air-mixing tube 41 having a larger diameter. The interior of the air-mixing tube 41 is formed into a hollow air-mixing chamber 42 and the top end of the air-mixing tube 41 is a screw hole 43 for locking to the spray gun tube 55. Next, the air-mixing tube, corresponding to the circumferential face of the interior of the tank 30 is provided with at least a pressure-increase hole 410. The pressure-increase hole 410 links the air-nixing chamber 42 and the tank 30 to communicate. The tubing module 40, at the bottom face of the air-mixing tube 41 is extended to a hollow combination tube 45. The combination tube 45 is connected to the air-mixing chamber 42 and is also extended downward to the interior base section of the tank 30, as shown in FIG. 5.

Accordingly, a cleaning device without reverse flow, which improves the cleaning efficiency of the combustion engine is obtained.

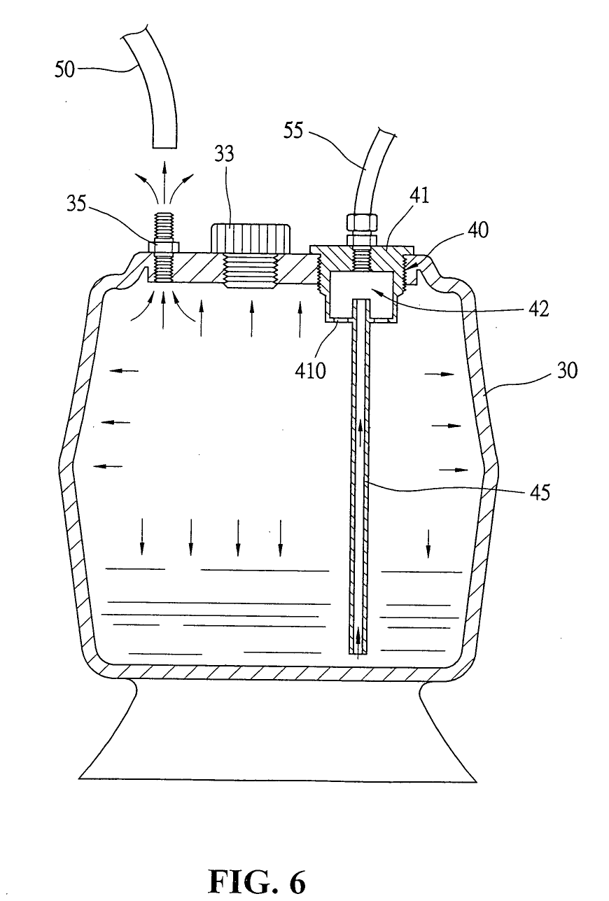

FIGS. 5 and 6 show a practical application of the cleaning device of the present invention. When the spray gun (not shown) of the spray gun tube 55 is depressed, the high pressure air enters the tank 30 via the air-inlet tube 50. The connecting tube 35 has yet to position at the bottom of the cleaning liquid within the tank 30, the high pressure air compresses the cleaning liquid, and the cleaning liquid flows upward via the combination tube 45. After the cleaning liquid arrives at the air-mixing chamber 42 of the air-mixing chamber 42, partial high pressure within the tank 30 enters the air-mixing chamber 42, and mutually mixed and impact within the air-mixing chamber 42 with the cleaning liquid. The cleaning liquid is formed into bubbles or atomized, and thus, when the bubbled or atomized cleaning liquid is sprayed into the combustion chamber, the adhesion force of the cleaning liquid on the wall face is improved and the time of adhesion is extended. Thus the efficiency of cleaning carbon by the cleaning liquid is greatly improved.

When the spray gun is closed and the air-inlet tube 50 is unplugged, the cleaning liquid within the tank 30 will not be ejected from the tank 30 as the connecting tube 35 does not contact with the cleaning liquid even when the high pressure air is discharged. Thus, there is no problem with respect to cleaning and there is no wastage of cleaning liquid.

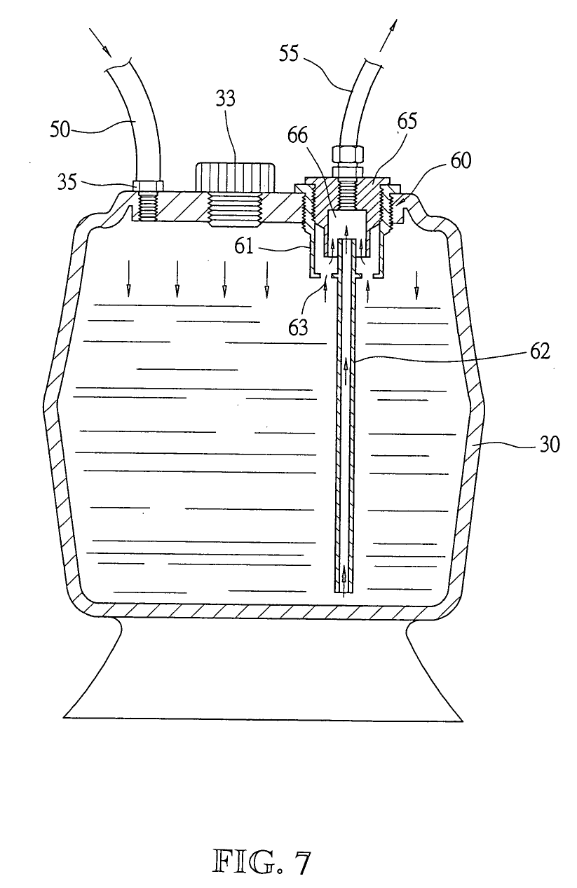

FIG. 7 shows another preferred embodiment in accordance with the present invention. The tubing module 60 includes a cylinder 61, and the bottom end of the cylinder 61 is extended into the combination tube 62 within the cleaning liquid. The cylinder 61, adjacent to the bottom face of the combination tube 62 is formed into a pressure-increase hole 63, and the interior of the cylinder 61 is provided with an air-mixing tube 65 connecting a spray gun tube 55. The air-mixing tube 65 is provided with an air-mixing chamber 66 and the combination tube 62 of the cylinder 61 can pass through the air-mixing chamber 66 of the air-mixing tube 65. Thus, when the cleaning liquid flows to the air-mixing chamber 66 via the combination tube 62, the high pressure air makes use of the pressure-increase hole 63 of the cylinder 61 and the gap between the combination tube 62 and the air-mixing tube 65 to enter into the air-mixing chamber 66. This will impact the cleaning liquid into bubbles or atomized.

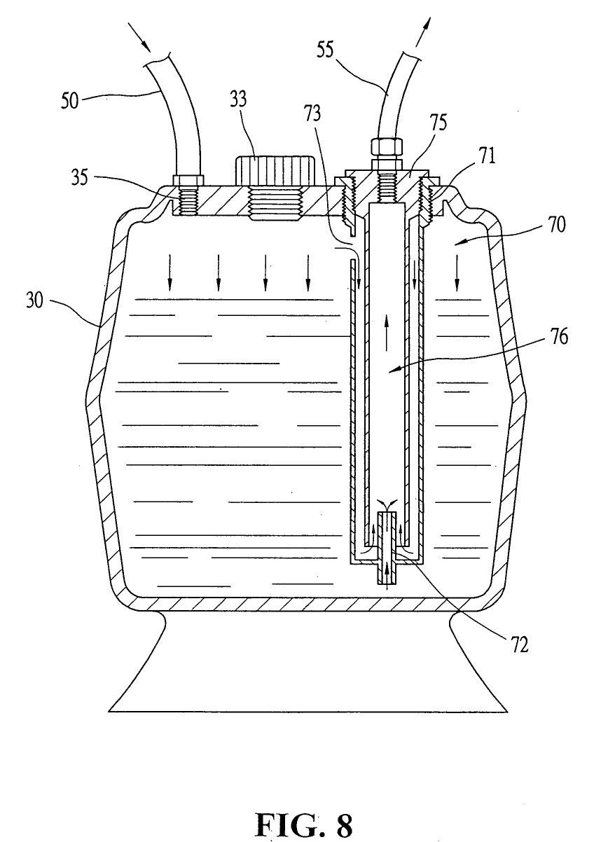

FIG. 8 is another preferred embodiment in accordance with the present invention. The tubing module 70 is a liquid outlet hole 34 of the tank 30 locked with an external tube 71 extended into the cleaning liquid in the tank 30. The bottom end of the external tube 71 is formed into a combination tube 72 and the circumferential face of the external tube 71 is higher than that of the pressure-increase hole of the liquid level of the cleaning liquid. Further, the external tube 71 is locked to the inner tube 75 connected to the spray gun tube 55. The inner tube 75 is extended to the combination tube 72 of the external tube 71 and the inner tube 75 is formed into an air-mixing chamber 76, so that the high pressure air from the pressure-increase hole 73 enters into the external tube 71 and the air-mixing chamber 76 of the inner tube 75, the cleaning liquid is formed into bubbles and atomized.

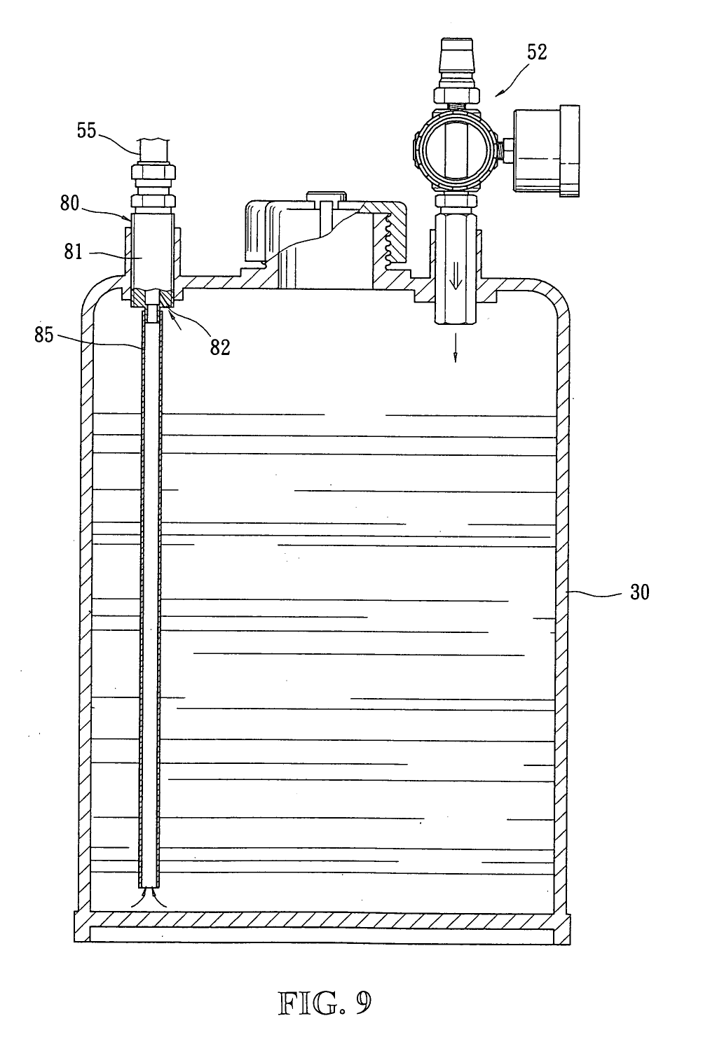

FIG. 9 is another preferred embodiment of the present invention. The tubing module 80 is a hollow air-mixing tube 81 mounted to the tank 30. The circumferential face of the air-mixing tube 81 is an inclined pressure-increase hole 82 linked to the tank 30 and the interior thereof.

The air-mixing tube 81 at the tank 30 has a downwardly mounted combination tube 85 extended into the cleaning liquid. Similarly, this will cause the cleaning liquid to become bubbles or atomized.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A cleaning device for a combustion chamber having a hollow tank for storage a liquid mounted with a tubing module and a connection hole for connecting with an air-inlet tube, characterized in that the top face of the tank is provided with a liquid inlet hole having a threaded cap, and the top end of the tank is an liquid-out connection hole for mounting with the tubing module, and the tubing module is connected to a spraying gun tube, and the air-inlet tube does not extend into the liquid in the tank and the tubing module has an air-mixing tube and a combination tube in communication with the interior of the air-mixing tube, and the combination tube extends into the liquid, and the surrounding of the air-mixing tube is a pressure-increase hole having a height higher than the height of the liquid, and the pressure-increase hole is in communication with the air-mixing chamber and the interior of the tank; whereby a cleaning device for combustion chamber is obtained.

2. The cleaning device of claim 1, wherein the tubing module is provided with an air-mixing tube of larger diameter and the interior of the air-mixing tube is a hollow air-mixing chamber, and the top end of the air-mixing tube is a screw hole for locking to the spraying gun tube, and the air-mixing tube, corresponding to the circumferential face of the interior of the tank is formed into at least a pressure-increase hole and the tubing module below the air-mixing tube is protrudingly extended to a hollow combination tube, and the combination tube is extended to the internal bottom section adjacent to the tank.

3. The cleaning device of claim 1, wherein the tubing module has a cylinder and the bottom end of the cylinder is protrudingly extended to the combination tube extending into the liquid, and the cylinder, adjacent to the bottom face of the combination tube is formed into a pressure-increase hole, and the cylinder is internally locked with an air-mixing tube connected to the spray gun tube, and the air-mixing tube is an air-mixing chamber, and the combination tube of the cylinder passes through the air-mixing chamber.

4. The cleaning device of claim 1, wherein the tubing module is locked to an external tube extended into the liquid at a liquid outlet hole, and the bottom end of the external tube is formed into a combination tube and the surrounding of the external tube is a pressure-increase hole having a height higher than that of the liquid, and the external tube is locked to an inner tube connecting the spray gun tube, and the inner tube is extended to the combination tube of the external tube and the interior of the inner tube is formed into an air-mixing chamber.

5. The cleaning device of claim 1, wherein the tubing module has a hollow air-mixing tube mounted to the tank and the circumferential face of the air-mixing tube is a pressure-increase hole connected to the tank and the interior thereof, and the air-mixing tube within the tank has a combination tube downward extended to the liquid.
